(19) United States
(12) Patent Application Publication
(10) Pub. No.: US 2008/0240932 A1
(43) Pub. Date: Oct. 2, 2008

(54) Pump, real-time, general and incremental condition diagnosis

(75) Inventor: Peter T. Carstensen, Adirondack, NY (US)

Correspondence Address: FROMMER LAWRENCE & HAUG, 745 FIFTH AVENUE- 10TH FL., NEW YORK, NY, 10151, US

(73) Assignee: Kadant Inc.

(21) Appl. No.: 11/728,535

(22) Filed: Mar. 26, 2007

(51) Int. Cl. F04B 49/00; G06F 11/30

(52) U.S. Cl. 417/63; 702/183

(57) ABSTRACT

A method and system for diagnosing a condition of a positive displacement hydraulic delivery system or pump. The method includes determining a reference polar guide of torque and/or velocity and/or energy profile(s) of the pump from a back electromotive force of a motor driving the pump, determining an angular displacement of an input shaft of the pump, comparing and storing the torque and/or velocity and/or energy profile(s) and the angular displacement of the input shaft in a processor within the motor drive, analyzing the torque and/or velocity and/or energy profile(s), thereby detecting any defect in the pump condition, and identifying a position of the defect based on the angular displacement of the input shaft of the pump.

### INTRODUCTION

1. Field of the Invention

The present invention relates to a method for real-time diagnosis of a hydraulic pump condition. More specifically, the invention relates to a method of diagnosis where the constant data stream provided by a shaft mounted position encoder and motor current signature analysis (MCSA), enable diagnosis of general and incremental pump conditions as well as the location of the node(s) (piston, chamber, cell and/or valve) in real-time.

2. Background of the Invention

High pressure fluid is useful in many industrial applications. For example, in the paper industry, water and other fluids are used to shower, clean and otherwise treat papermaking fabrics used to form and dry a continuous paper sheet. These fabrics accumulate contaminants from the process, which must be removed, in addition to other deterioration in properties, which result from the applications and environment in which they are used. For example, a press fabric may be required to pass through one or more high pressure nips which apply great compressive pressure. The nip pressure causes the fabric to compress and close, affecting such operational characteristics as permeability of the fabric to water flow. These characteristics are critical to fabric operation.

There are essentially two basic methods to apply fluid to fabrics to affect operational characteristics. Low pressure, relatively high volume fluid can be applied to essentially flush contaminants away and flood or almost flood void volumes of fabrics. Higher pressure, lower volume flow can be applied, usually in concentrated streams, to apply power to the fabric and thus remove contaminants and mechanically affect other characteristics. In this regard see for example U.S. Ser. No. 08/498,909 entitled “Apparatus and Method of Fabric Cleaning”, filing date Jul. 6, 1995 which has been allowed and which is commonly assigned and whose disclosure is incorporated herein by reference.

Conventional pressures in papermaking seldom exceed 2,500 psi since the generation of high pressures (up to 5,000 psi) in incompressible fluids is expensive and requires apparatus of inherent limitations. The pumping of incompressible fluid may be accomplished in a large number of ways. Most conventional and efficient is a rotating vane pump. Such a pump generally depends on a rotary impeller imparting energy to a fluid via centrifugal force. These pumps are common, and exist in a myriad of forms. In conventional applications, they are typically limited, however, to pressures of much less than 1,000 psi. As applications vary there is usually slippage within the pump body, which generates heat. If the application flow is allowed to fall below a specific threshold, cavitation or media vaporization occurs. The conventional method employed to prevent the aforementioned situation from occurring is to insure sufficient flow through the pump cavity. This is accomplished with use of waste gates or combination recirculation and cooling loops.

In the case where higher pressures are desired, there are fewer alternatives. This usually involves a positive displacement apparatus. A positive displacement pump is most commonly a variation of a reciprocating piston and cylinder, the flow which is controlled by some sort of valving. Reciprocal machinery is however less attractive than rotary machinery because it is inherently more complicated and less reliable than the rotary type. More importantly the output of a reciprocal machine is cyclic. The cylinder alternately pumps or fills. Therefore, there are breaks in its output. This disadvantage can be overcome to a certain extent by using multiple cylinders, and by passing the pump output through flow accumulators, attenuators, dampers or, as commonly done, waste gate the excess pressure thereby removing the high pressure output portion of the flow.

In addition to uneven pressure and flow output, reciprocating pumps have the disadvantage of uneven power input proportional to their output. This causes excessive wear and tear on the apparatus, and is inefficient because the pump drive must be sized for the high torque required when the position of the pump connecting rod or cam, in the case of an axial (wobble plate) pump, is at an angular displacement versus the crank arm dimension during the compression stroke that would result in the highest required input shaft torque.

Moreover, if the demand of the application varies, complicated bypass, recirculation, or waste gate systems must be used to keep the system from “dead-heading.” That is, if flow output is blocked when the pump is in operation, the pump either breaks down by the increased pressure or stalls. If stalling occurs, a conventional induction electric motor will burn out as it assimilates a locked rotor condition with full rated voltage and amperage applied. Typically, systems with fixed displacement pumps use a relief valve to control the maximum system pressure when under load. Therefore, the pump delivers full flow at full pressure regardless of the application thus wasting a large amount of power.

It should be further noted that previous attempts to provide a high dynamic range, in the macro sense of operation, of hydraulic flow and pressure during operation of prior pumping systems, required placement of downstream devices in the liquid path to modulate the hydraulic output. With such systems, the pump provides the maximum hydraulic flow (as the prime mover) and the downstream devices adjust the output to match the application requirements.

When, however, the torque profile is compared with the input shaft displacement and other known factors such as system inertia and response time of the pump drive, etc, a pump can produce constant pressure and therefore, constant flow without the typically associated ripple common to power pumps, for the full range of the designed volumetric delivery, by driving the pump in a feed forward method.

It should be noted that most of the hydraulic pumping systems control output pressure and flow in the macro sense. These concepts examine modulating the input shaft torque and speed to provide a constant hydraulic output, whether it is pressure or flow limited. For example, see commonly assigned U.S. Pat. No. 5,971,721, U.S. Pat. No. 6,652,239 and U.S. Pat. No. 6,494,685, the contents of which are hereby incorporated by reference.

Positive displacement hydraulic delivery systems, however, require preventative maintenance to be performed in order to prevent unexpected malfunction or diminished output. Common practice in the industry is to wait until a defect is pronounced, such as, by means of poor performance, before taking any action. This method interrupts production schedules, which can lead to lost productivity and hence increased cost.

Preventative maintenance routines have employed, for example: inspection and/or replacement at regular intervals; replacement of pump wear components at regular intervals; and data logging and evaluation of various output energy components. It is also typical on critical pumping systems to add transducers and monitoring equipment for early detection of failure modes. All these methods, however, target the general condition of the pump assembly.

The methods described above require a scheduled curriculum of tasks or, in the event of critical systems, added hardware and associated evaluation and data processing components are necessary.

Therefore, a need exists for a system that diagnoses a condition of a pump without a scheduled curriculum of tasks or added hardware and associated evaluation and data processing components.

### SUMMARY OF THE INVENTION

The present invention relates to a method and system for real-time diagnosis of general and incremental conditions of a hydraulic pump. The method and system for diagnosing a condition of a positive displacement hydraulic delivery system or pump, comprises determining a reference polar guide of toque and/or velocity and/or energy profiles of the pump from a back electromotive force of a motor driving the pump, determining an angular displacement of an input shaft of the pump, plotting and storing the torque and/or velocity and/or energy profiles and the angular displacement of the input shaft in a processor within the motor drive, analyzing the torque and/or velocity and/or profiles, thereby detecting any defect in the pump condition; and identifying a position of the defect based on the angular displacement of the input shaft of the pump. More specifically, the invention relates to a method of diagnosis of a hydraulic pump where the constant data stream provided by a shaft mounted position encoder and motor current signature analysis (MCSA) enable not only diagnosis of general and incremental pump conditions but also the location of the node(s) (piston, chamber, cell or valve) in real-time.

It is therefore an object of the present invention to provide a method for diagnosing a pump condition by electronically monitoring pump torque, velocity and/or energy variations in the micro-sense.

It is a further object of the present invention to provide a method for diagnosis of a pump condition based on high-resolution variation in the power and torque output of a pump motor.

It is still a further object of the present invention to develop a torque and/or velocity and/or energy signature that is recognized as a general pump condition indicating the presence or absence of an inlet suction.

It is a further object of the present invention to provide a method for diagnosing a pump condition that uses an algorithm to warn an operator of an undesirable inlet condition that develops or exists in a pump.

Yet another object of the present invention is to recognize general pump conditions such as unloaded output, cavitation, catridge seal failure, disconnected shaft coupling, all inlet valve failure, all outlet valve failure, no inlet flow, leak detection, and line burst.

A still further object of the present invention is to diagnose incremental pump conditions such as an inlet check valve wear/failure, outlet check valve wear/failure, piston seal leak/efficiency, wobble plate shoe wear, wobble plate bearing wear, seal leakage, single node cavitation, and efficiency of each node.

A further object of the present invention is to provide a method for diagnosing a pump condition that uses an algorithm to warn an operator that a node failure is developing or existing.

It is therefore a further object of the present invention to provide a method for diagnosing a pump condition that not only detects the condition of failure but also identifying the location of the failing component in the pump.

A still further object of the present invention is to allow a user to predict well in advance, potential problems that are normally masked and invisible when a “general pump condition” evaluation is implemented.

These and other objects and advantages are provided by the present invention. In this regard, the present invention provides a method for obtaining a polar map within the electronic drive of a targeted pump. This polar map is calculated by a processor or is externally calculated and then input into a processor. After the torque, velocity and/or energy profiles of the pump are obtained and translated into a polar map, the processor compares the shaft displacement angle of the pump's input shaft to the reference polar map and yields signatures that correspond to a condition of the mechanical components as the energy transfer takes place. The processor can also take into account selected factors such as the response time of the pump drive, the motor inductive reactance, system inertia, application characteristics of the pump, and regenerative energy during deceleration of the pump.

Using selected factors and the comparison results, the processor then signals the operator of any anomaly in the pump operation, indicating a bad condition of the pump. With a constantly monitored motor torque, velocity and/or energy output in concert with the established polar map (for the targeted pump), the pump characteristics can be determined in real-time.

All features listed herein may be integrated into the system by developing algorithms and subroutines for the diagnosis system coupled to the hydraulic pump.

The present invention will now be described in more complete detail with reference being made to the figures identified below.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 illustrates a method for diagnosing a pump condition, according to one aspect of the invention,

FIG. 2 is a graph depicting a theoretical velocity profile of a pump with no suction inlet, according to one aspect of the invention;

FIG. 3 is a graph depicting a theoretical velocity profile of a pump with suction inlet, according to one aspect of the invention;

FIG. 4 depicts a polar velocity profile of a pump with no defect, according to one aspect of the invention; and

FIG. 5 depicts a polar velocity profile of a pump with a valve defect, according to one aspect of the invention.

The description of the various elements of the invention will be discussed in detail in the following sections.

### DETAILED DESCRIPTION OF THE INVENTION

The instant invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

The present invention relates to a method for real-time diagnosis of general and incremental conditions of a hydraulic pump. More specifically, the invention relates to a method of diagnosis where the constant data stream provided by a shaft mounted position encoder and motor current signature analysis (MCSA), enable diagnosis of general and incremental pump conditions as well as the location of the node(s) (piston, chamber, cell or valve) in real-time.

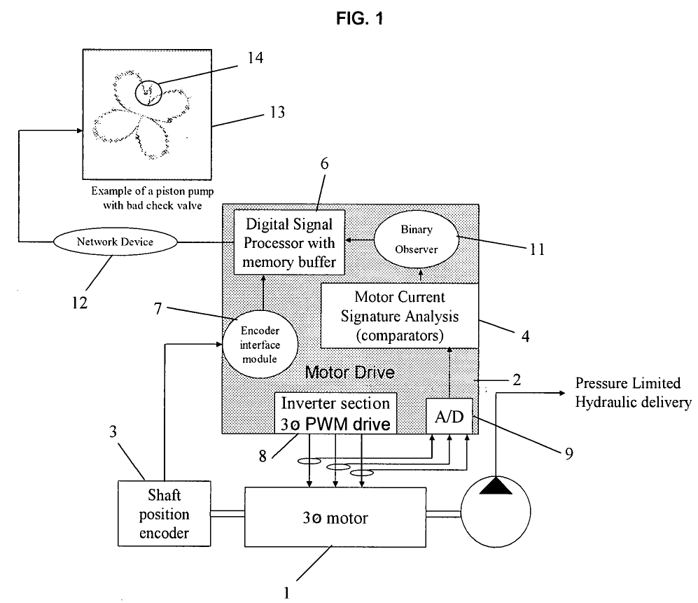

Referring now to the Figures, FIG. 1 illustrates a method of diagnosing a pump condition according to one embodiment of the invention. In this embodiment, a shaft position encoder 3 is integrated into the motor pump assembly 1 to record the angular displacement of the pump crank shaft, or simply, the shaft position. This data stream is constantly recorded by a digital signal processor (DSP) 6, which has a memory buffer, via an encoder interface module 7.

Simultaneously, the motor current signature analysis or MCSA 4 data is typically processed by means of an A/D converter 9 from the back electromotive force (EMF) of the motor power feed leads coming out of the inverter section 8 of the pulse width modulated (PWM) motor drive 2, and extracted from this PWM power driving the drive motor by a common mode rejection of the pulse width modulated power supplied. This data is digitally transferred to the DSP 6 that also includes a memory buffer, via a binary observer 11. Comparison of both data, data from the shaft position encoder 3 and the MCSA 4, yields signatures that correspond to particular pumping demands and the condition of the mechanical components as the energy transfer takes place. For instance, a piston pump signature with a bad check valve 14 is shown, for example, in Box 13 of FIG. 1. In other words, the motor drive's observer 11 software is tasked to arm and trigger torque and/or velocity and/or energy verses position data for every pump revolution. This data is stored in the DSP's 6 memory buffer and is uploaded to a data logging/charting application in real-time. According to one embodiment of the present invention, this data can be displayed for diagnostic analysis 13 through a network device 12, which may further be connected to a control mechanism for temporary compensation of the pump condition thereafter.

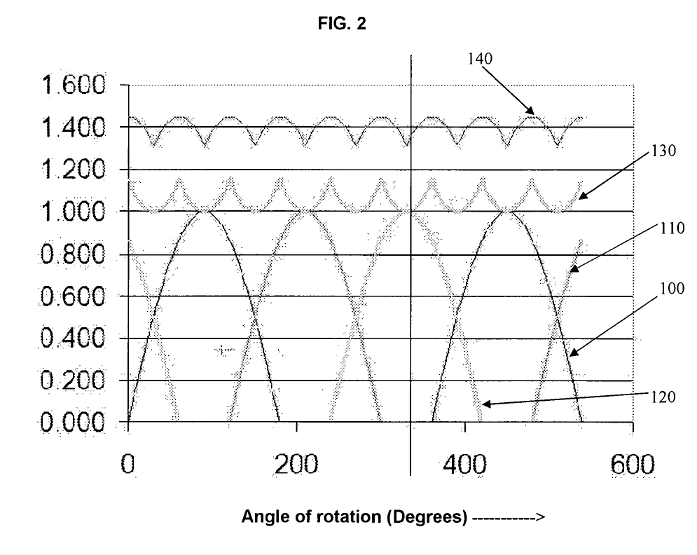

An example of the data generated according to one embodiment of the present invention is shown FIG. 2, Example 1, which graphically depicts a typical velocity variation in a velocity profile of a triplex or three node pump (three volumetric displacements per revolution) versus the angular displacement of the pump crank shaft (in degrees) at a constant torque without any inlet restriction. As shown, each velocity curve and each pressure curve, independently, are equal to the preceding one. That is, all of the velocity curves are identical to each other and all of the pressure curves are identical to each other. Outputs 100, 110 and 120 indicate the displacement of the three pistons with respect to an angle of rotation of the crank shaft on the x-axis, and outputs 130 and 140 relate to the output pressure of the pump in kilo pounds per square inch (Kpsi; 1 Kpsi=6.9 MPa) and the volume flow or output of the pump in gallons per minute (gpm; 1 gpm=0.003785 m³/min) respectively.

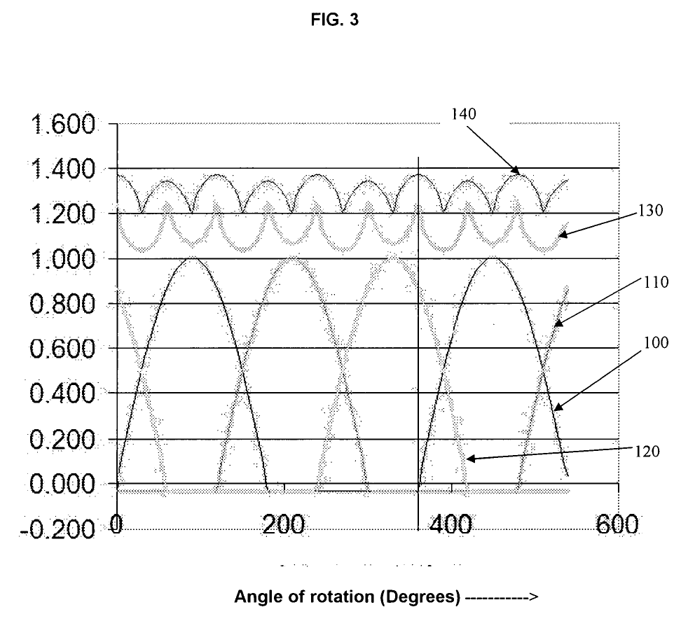

In a further example, however, Example 2 shown in FIG. 3 depicts a velocity profile of a pump with an inlet restriction at constant torque. In that, the curves are cyclical, with alternating amplitudes, wherein outputs 100, 110 and 120 indicate the displacement of the three pistons with respect to an angle of rotation of the crank shaft on the x-axis, and outputs 130 and 140 relate to the output pressure of the pump in kilo pounds per square inch and the volume flow or output of the pump in gallons per minute respectively. It is observed from the data that even a slight restriction in the inlet causes a change in the output pressure of the pump and the volume flow or output of the pump. Specifically, Examples 1 and 2 demonstrate a velocity signature that would be recognized as a general pump condition indicating inlet suction presence (FIG. 3) or absence (FIG. 2), according to one embodiment of the present invention.

Particularly in this embodiment, if a profile depicted in FIG. 3 occurs, the algorithm warns the operator of an undesirable inlet condition that is developing or existing. For instance, in this example the pump condition can be an inlet screen beginning to restrict flow. Other signatures that can be detected for general pump condition include, but are not limited to, unloaded output, cavitation, catridge seal failure, disconnected shaft coupling, all inlet valve failure, all outlet valve failure, no inlet flow, leak detection, and line burst.

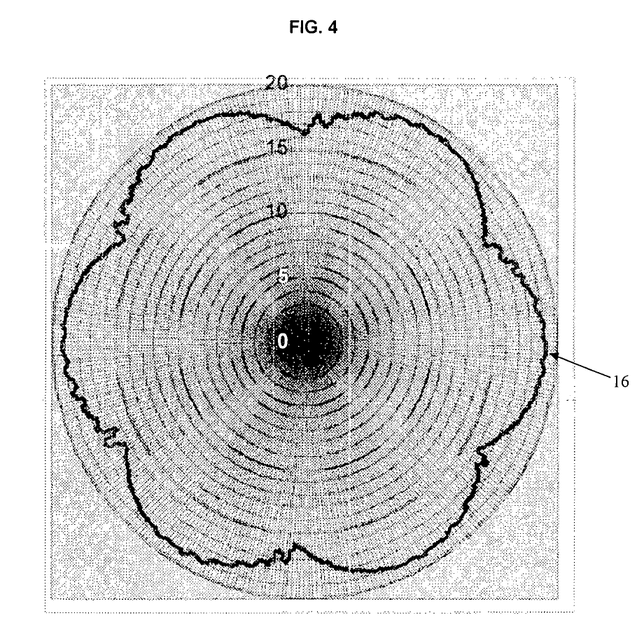

FIG. 4 graphically depicts a pump polar map 16 that is determined based on the velocity profile and the input shaft angular displacement of the pump. Depicted orbitally along the angular displacement of the targeted pump's input shaft is the velocity profile, in which the center 0 of the polar map represents zero velocity, which thereafter increases in incremental numbers from 5-20 (rpm×10 inches) or 50-200 rpm. The distance of each point plotted on the polar map's 16 center from the base diameter's center is the geometric distance variation (over or under) of the base radii percentile established from velocity versus the pump input shaft displacement angle. The velocity versus angular displacement profile of the pump system selected becomes the reference polar guide for the comparator algorithm in the processor of the diagnosis system. Threshold values are set for both lower and upper limits of velocity in the comparator algorithm, surpassing which indicates a failure in a certain condition of the pump. Although the diagnosis of a condition of the hydraulic pump explained herein involves the determination of a velocity profile of the motor drive under constant torque, determination of torque and energy profiles of the motor drive at different conditions, such as constant velocity, constant energy etc., using a back e.m.f. from the power driving the motor drive, falls well within the scope of the present invention.

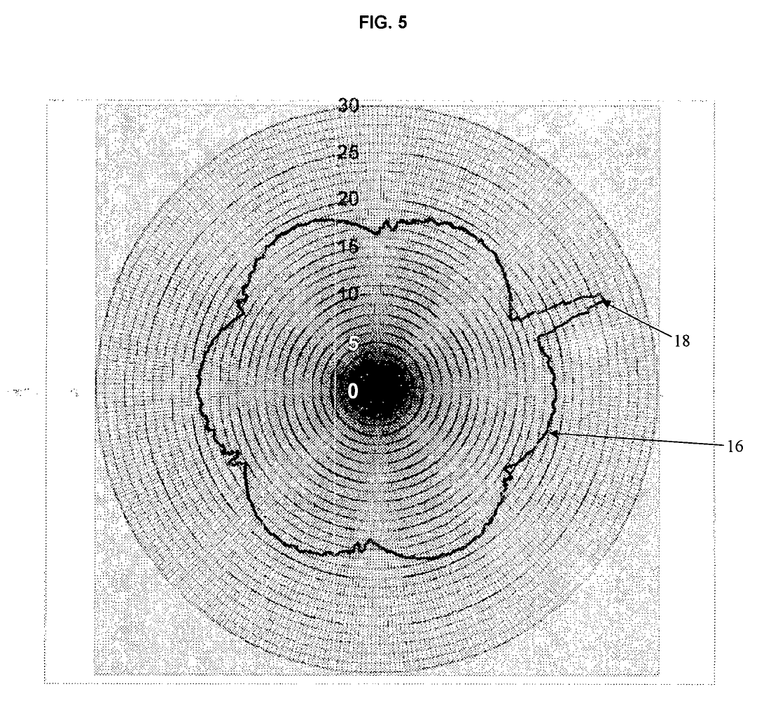

For instance, Example 3 shown in FIG. 4 depicts a polar velocity profile 16 of a pump at constant torque with no defect. In a further example, Example 4 shown in FIG. 5 depicts a polar velocity profile 16 of a pump at constant torque with a valve defect. In this case, Example 4 (FIG. 5) demonstrates a velocity signature 16 that would be recognized as an incremental pump condition indicating a single check valve failure due to a peak 18 detected in the polar guide. According to this embodiment, the algorithm warns the operator that a node failure is developing or existing. In this example, in addition to detecting a failure condition, the location of the failing component (18) can also be identified.

According to one embodiment of the present invention, other signatures that are recognized as incremental pump conditions include but are not limited to, inlet check valve wear/failure, outlet check valve wear/failure, piston seal leak/efficiency, wobble plate shoe wear, wobble plate bearing wear, seal leakage, single node cavitation, and efficiency of each node, which can be displayed using a display device or external output. This advanced pump condition information allows a user to predict potential problems that are normally masked and invisible when a “general pump condition” evaluation is implemented well in advance of conventional methods.

Although the disclose embodiments use the velocity profile of the motor drive of a hydraulic pump to determine the condition of the pump, it will be readily apparent that one skilled in the art can also use torque or energy profiles of the motor drive of a hydraulic pump to determine the condition of the pump, which can be envisioned within the scope of the present invention.

Several exemplary diagnosis features of the present invention are described in greater detail below. These features represent only a fraction of the possible features that may be electronically integrated into a hydraulic system using algorithms and subroutines for the diagnosis system that is included on a pump.

“Pressure Loop” Feature: This feature provides a pump shaft torque output measurement method that is translated into a pressure delivered signal.

“Position Sensing” Feature: According to this feature, a volumetric pulse correlates to a pump output volume that will cause an incremental pulse to occur. This volumetric pulse (output by the electronic drive module) is used for the positioning of known hydraulic cylinders and their corresponding volumetric displacements.

“Leakage Detection” Feature: This subroutine is used to detect user defined excessive hydraulic leakage rates. This feature compares the output of the “Position Sensing” function to a known limit during a move, and if there is a discrepancy beyond a predetermined amount, an alarm output results.

“Output Gain Offset” Feature: This feature allows the user to assess the output gain levels of the hydraulic delivery (pressure vs. flow) in order to overcome any application flow restrictions or mechanical variation. The assessment results in a profile of torque vs. velocity for the desired hydraulic output.

Thus, while fundamental novel features of the invention are shown and described and pointed out, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in another form or embodiment. It is the intention, therefore, to be limited only as indicated by the scope of the claims appended hereto.

1. A method for diagnosing a condition of a positive displacement hydraulic delivery system or pump, comprising the steps of:
determining a velocity profile of the pump from a back electromotive force of a motor driving the pump,
determining an angular displacement of an input shaft of the pump;
plotting and storing the velocity profile vs. the angular displacement of the input shaft in a processor within the motor drive, thereby creating a polar map;
analyzing the polar map, thereby detecting any defect in the pump condition; and
identifying a position of the defect based on the angular displacement of the input shaft of the pump.

2. The method according to claim 1, wherein the velocity profile of the pump is determined using a motor current signature analysis.

3. The method according to claim 2, wherein the motor current signature analysis is produced by means of an A/D converter that receives the back electromotive force of the motor driving the pump, extracted from a pulse width modulated power driving said drive motor by a common mode rejection of said pulse width modulated power.

4. The method according to claim 1, wherein a signal from the motor drive is pulse width modulated.

5. The method according to claim 1, wherein the angular displacement of the input shaft of the pump is determined using a shaft position encoder.

6. The method according to claim 1, wherein the processor is a digital signal processor with a memory buffer.

7. The method according to claim 1, further comprising the step of transferring the diagnosis data to a control mechanism for a temporary compensation of the pump condition.

8. A hydraulic delivery system or pump system comprising:
determining means for determining a torque and/or velocity and/or energy profile of the pump from a back electromotive force of a motor driving the pump; and
position means for determining an angular displacement of an input shaft of the pump;
diagnosing means for diagnosing a condition of a pump based on the torque and/or velocity and/or energy profiles of the pump and the angular displacement of the input shaft of the pump.

9. The pump system according to claim 8, wherein said diagnosing means creates a polar map by plotting and storing the torque and/or velocity and/or energy profiles vs. the angular displacement of the input shaft.

10. The pump system according to claim 8, wherein said diagnosing means analyzes the polar map, thereby detecting any defect in the pump condition.

11. The pump system according to claim 8, wherein said diagnosing means identifies a location of the defect based on the angular displacement of the input shaft of the pump.

12. The pump system according to claim 8, wherein the torque and/or velocity and/or energy profiles of the pump are determined using a motor current signature analysis.

13. The pump system according to claim 12, wherein the motor current signature analysis is produced by means of an A/D converter that receives the back electromotive force of the motor driving the pump, extracted from a pulse width modulated power driving said motor drive by a common mode rejection of said pulse width modulated power.

14. The pump system according to claim 8, wherein a signal from the motor drive is pulse width modulated.

15. The pump system according to claim 8, wherein the angular displacement of the input shaft of the pump is determined using a shaft position encoder.

16. The pump system according to claim 8, wherein the processor is a digital signal processor with a memory buffer.

17. The pump system according to claim 8, further comprising a control means for a temporary compensation of the pump condition.

18. A method for diagnosing a condition of hydraulic pump comprising the steps of:
determining a velocity profile of the pump based on a back electromotive force of a motor driving the pump;
storing the velocity profile in a processor within the motor drive;
analyzing the velocity profile to determine a defective pump condition.
